(19) United States
(12) Patent Application Publication
(10) Pub. No.: US 2018/0091482 A1
(43) Pub. Date: Mar. 29, 2018

(54) Web Application Perpetually Encrypted Obscured Filesystem

(71) Applicant: eSecured Transaction Services LLC, San Antonio, TX (US)

(72) Inventors: John Steele, Breckenridge, CO (US); Adam Ainsworth, Superior, CO (US); Robert Catalano, Sunnyvale, CA (US)

(73) Assignee: eSecured Transaction, LLC, San Antonio, TX (US)

(21) Appl. No.: 15/279,428

(22) Filed: Sep. 29, 2016

(51) Int. Cl. H04L 29/06; H04L 9/08

(52) U.S. Cl. CPC H04L 63/0428; H04L 9/0894; H04L 9/0869

(57) ABSTRACT

This disclosure relates generally to a computing system and method for data encryption and, more particularly, to methods and apparatus for enhanced protection of data transmitted to and from, as well as stored on file systems associated with an internet service application using integrated mechanisms and processes for data obscurity, secure sleep state encryption, and separation of concerns.

This application claims benefit of priority from U.S. Provisional Application No. 62/177,009 filed Mar. 2, 2015, which is hereby incorporated by reference in its entirety for all purposes.

### BACKGROUND

Computing applications and platforms available through online services such as SaaS (software as a service applications) store information that a user may deem secret, sensitive, and/or otherwise not wish it for public access, herein referred to as Internet Service Applications (ISA). The data transmitted, stored, and accessed by users and service hosts of such applications are stored in file systems. Such data transmitted and stored on such applications are herein referred to generally as Proprietary Data. Such data and file systems are vulnerable to hacking by people and systems not legally authorized to access the Proprietary Data.

When a computer or file system is hacked, access is gained to the Proprietary Data in the file system. Once a hacker is able to infiltrate a file system, meaningful metadata and file names are typically used to locate and procure Proprietary Data that seem valuable to the hacker. The security of the Proprietary Data contained in the file systems is then compromised, often causing significant loss and damages to the Proprietary Data owner and/or application host.

Typically, files on a webserver are not encrypted and adhere to a human readable naming convention. For example, a user named John Smith, who has a loan at the bank National Bank, might have a document with his 2015 personal tax information saved with the bank containing his loan information, named with some level of descriptive information, for example: C:\Loans\NationalBank\JSmith\JSmith2015w2.pdf. This is a file name with useful information to most interested parties to the loan, however, the usefulness also extends to potential hackers or unauthorized people managing automated algorithms whose intentions are not in the interests of the bank or the user. Having access to descriptive information available on filenames gives unauthorized users clues to associated data and other related files.

A method and apparatus to overcome these security related shortcomings is . available through the present invention of a perpetually encrypted secured filesystem through enhanced secure sleep state encryption, referred to herein as “ESSSE”.

### SUMMARY

Methods and apparatus for enhanced protection of documents, information and data on a filesystem and database through an enhanced computing platform for sleep state encryption are disclosed. The invention incorporates enhanced security through file name obscurity, enhanced sleep state encryption, and separation of concerns, to create a novel and improved platform and software innovation for data protection including proprietary data owned or managed by an entity seeking to protect such data. Such a filesystem on a computing platform is typically used for an internet service application (ISA) that is independently managed by an entity through a network of private, shared, local or cloud-based databases, referred to also as storage units.

An example method of the apparatus of the present invention includes, in response to user attempts to upload data through a computer interface to the ISA application, folder and file names where such data is stored, are obscured with computer generated random guids; when such obscured folder and file names are obscured, files stored on the system folders are encrypted to thwart human understanding as they are collected prior to manipulation or later dissemination. The encryption key and meta data for the encrypted files are stored in a separate database.

### BRIEF DESCRIPTION OF THE DRAWINGS

FIG. 1 is a block diagram of an example computing platform including an example enhanced secure sleep state encryption (ESSSE) module for upload of files to an internet service application (ISA) as described herein.

FIG. 2 is a block diagram of an example computing platform including an example enhanced secure sleep state encryption (ESSSE) module for download of files to an intemet service application (ISA) as described herein.

FIG. 3 is an illustration of an implementation of the present invention representative of example machine readable instructions that may be executed during upload functions of Proprietary Data to an ISA to implement the example ESSSE enhanced secure sleep state encryption module of FIG. 1.

FIG. 4 is an illustration of an implementation of the present invention representative of example machine readable instructions that may be executed during download functions of Proprietary Data to an ISA to implement the example ESSSE enhanced secure sleep state decryption module of FIG. 2.

FIG. 5 is an illustration of an alternative implementation of the present invention representative of example machine readable instructions that may be executed during upload functions of Proprietary Data to an ISA to implement the example ESSSE enhanced secure sleep state encryption module of the present invention.

FIG. 6 is an illustration of an alternative implementation of the present invention representative of example machine readable instructions that may be executed during download functions of Proprietary Data to an ISA to implement the example ESSSE enhanced secure sleep state module of the present invention.

### DETAILED DESCRIPTION

Volatility of data is a danger as keys and salt values used during data cryptography are stored in a database. In the event of a catastrophic database failure inclusive of failure to restore from backup, the filesystem becomes unusable and all file history may be lost. In the event of database failure with successful restoration, any files uploaded or modified between backups may be lost.

For example, when a computer is hacked or access attempted by an unauthorized user, the hacker has gained access to the file system on the database. When files and folders have typical naming conventions, the names are very useful tools to hackers or unauthorized users to determine the subject matter of their contents and thus the likelihood of useful data to be compromised is significant.

A sleep state for encryption of data through a computing platform and system having database storage, computer processing and software algorithms to enhanced features to prevent meaningful access to personal or private information, also referred to herein as Proprietary Data, avoids these drawbacks and is described herein. To protect a file system containing Proprietary Data, a suite of mechanisms are integrated for more secure encrypted data in an internet service platform.

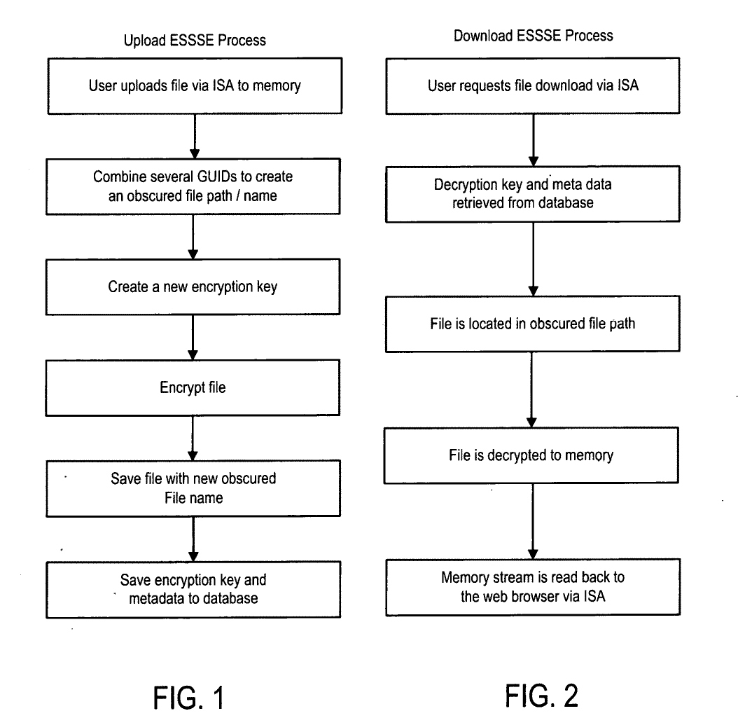

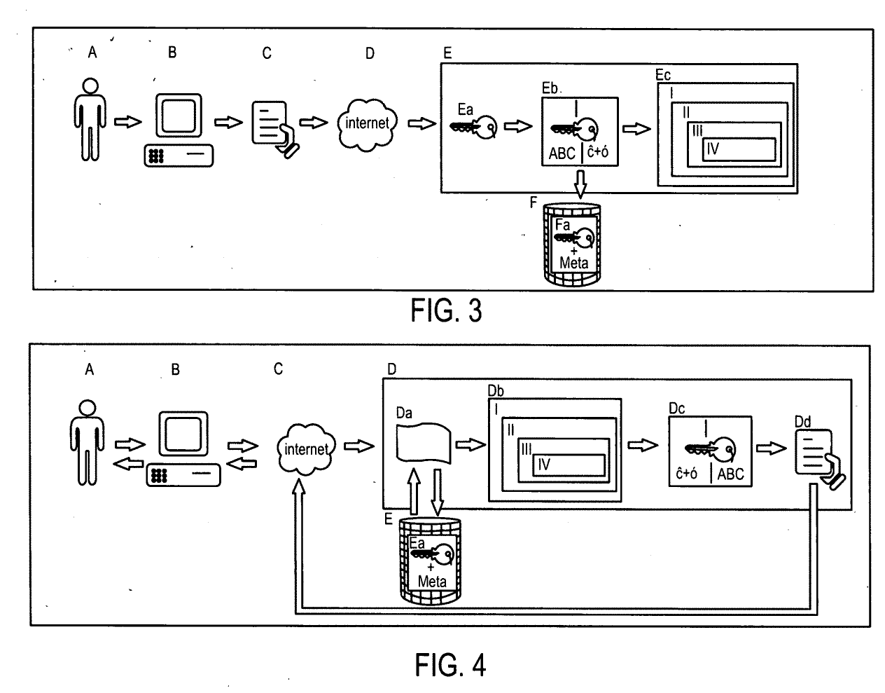

FIGS. 1 and 2 are block diagrams of the steps involved in the upload and download of files, respectively, through the present invention, further described in corresponding detail in FIGS. 3 through 6.

The benefits of the enhanced secure sleep state encryption (ESSSE) platform described herein over the prior art processes for encryption of data include encrypted files and file names rather than files saved in clear text, and the placement and storage of the encryption key and obscured file meta data in a separate database from the encrypted files. An obscured filesystem structure provides a meaningless view in the directory structure over a directory structure that is human readable, such as c:\Loans\NationalBank\JSmith.

Once in the file system hackers typically begin searching the file system for documents with meaningful metadata and file-names. As illustrated in the flow chart of FIG. 1, once a User of an ISA uploads a file to the network on which the ISA resides, the software algorithms instruct the system processor to request the process of security through obscurity on directories, sub directories, files and meta data. As a comparison of the practical usefulness of stripping of metadata, unauthorized users, through manual attack by programmers, or computer generated automated trolling, or no longer have a point of origin or reference over a file name such as JSmith2015w2.pdf compared with 8c097876-cf70-4719-a4f5-37ca82f026e0, which represents an example of the same file name after the steps have been carried out on the computing platform for enhanced secure sleep state encryption of the present invention.

Rather than a typical conical file structure to the effect of Company Name, Loan Name, John Doe's 2014 w2.pdf; the file system of the present invention is obscured using GUIDs (Globally Unique Identifiers), which are implementations of the universally unique identifier standard (UUID), and that transform the file structure from the previous example into the following exemplary conical file structure:
279e19ef-470d-49ac-b6b1-3a5210637767,d44df3d5-96cc-4484-b50d-78b2019b1000,91fb594c-6ea6-47b6- b3c0-a85c4348d574

A GUID (global unique identifier) is a term for a number that programming generates to create a unique identity for an entity, such as a Microsoft Word document, for example. GUIDs are widely used to identify interfaces, replica sets, records, and other objects. Different kinds of objects have different kinds of GUIDs—for instance, a Microsoft Access database uses a 16-byte field to establish a unique identifier for replication. GUIDs are usually stored as 128-bit values, and are commonly displayed as 32 hexadecimal digits with groups separated by hyphens, such as {21EC2020-3AEA-4069-A2DD-08002B30309D}. They may or may not be generated from random numbers. Alternatively, a programmed manner of encryption may be utilized whereby pseudo-random or formulated numbers are generated through algorithm via the obscuration step of the present invention.

Through the utilization of GUIDs rather than nouns or other logical text in combination with stripping the metadata from the data file, an unsearchable file system that is retardant to searches for *.pdf, *.xls, *.* and other recognizable words, terms and meaningful strings of characters is created. The same file name as modified through the computing platform of the present invention would appear in an exemplary embodiment instead as:
c:\c46f22b1-4369-406b-ba9d-7c7afc4420df\\29b4671e-e6fa-4faf-9343-c462121278d2 \3830af2c-30b7-47d0-a904-ebf151d166d8\3975593b-6666-4c6c-ba18-aca8afffc296 \f2504f0f-1268-4715-ac4a-7322bc7079d4.
   This encrypted transition of file name now has little to no practical usefulness to an unauthorized person or computer, thus making access to the associated data through the file name more difficult.

When a file is uploaded to the server, the new GUID is created to reference the file. In addition, the algorithms instruct the processor to request that a new key is generated and used to encrypt the file. The technique utilized for file encryption upon upload is through using a uniquely generated key for each file, and in a preferred embodiment, the encryption is executed using the Rjindael encryption algorithm. The Rjindael encryption algorithm had been selected by the US National Institute of Standards & Technology as the Advanced Encryption Standard (AES) in 2001. The Advanced Encryption Standard is the default encryption algorithm used by the U.S. government to protect classified information, and its symmetric key algorithm is implemented in software and hardware throughout the world to encrypt sensitive data.

After the file is encrypted, the encrypted version of the file is then saved to the file system using the file reference GUID. By implementing the process of encrypting the file then saving the file with a GUID file name rather than a file with a .pdf (or any other extension for that matter) any meta data visible to the operating system is effectively removed. It simply appears as, “File” or other consistent and generic reference.

Once the file has been saved using the obscured file name, the key used to encrypt the file is then saved in a separate database implementing a concept of separation of concerns. The key is used in the future to decrypt the data file upon a download request along with some basic meta data harvested from the data file prior to encryption that is also separately stored in a database independent from the encrypted file.

In computer science, separation of concerns is a design principle for separating a modular computer program into distinct sections, such that each section addresses a separate set of information that affects the code of a computer program. Modularity, and hence separation of concerns, is achieved by encapsulating information inside a section of code that has a well-defined interface so as to minimize functionality overlap among different sections.

The decryption method to access the file upon a download request is similar. The document retrieval id (or document GUID) is passed into the ISA application upon request by the processor. The application queries the database through algorithms for the previously saved metadata which will be used to locate and decrypt the encrypted file and tell the browser what type of application will be needed to open the file.

As shown in the steps of FIG. 2, after the decryption key and meta data have been retrieved from their separate database for the file, the encrypted file is then decrypted using the Rinjdael encryption algorithm and then read back to the client's web browser through a memory stream as a new download. It is contemplated that the decryption key and metadata could each be separately stored in individual databases separate from the encrypted file for additional security from unauthorized users.

The integration of the concepts of security through obscurity, AES (or other Method for) file encryption, and separation of concerns provides a novel and enhanced method and system for data encryption and secure data storage.

In the event of physical compromise via internal or external sources the filesystem should not be in clear text. By obscuring folder and file names with guids and implementing encryption techniques on files the directory structure becomes undecipherable and offers an improved level of protection to our clients. Through the utilization of this technique, files are unreadable outside of the application by any user—including even those personnel having access to the software/source code/administrative authority for the ISA.

In a preferred embodiment of the invention, the system and method for enhanced encryption and protection of Proprietary Data of the present invention is described. As illustrated in FIG. 3, the system and processes of a User of the ISA logging into the ISA through a computer interface to the ISA (stages A and B) in order to upload files within the webserver hosting the ISA (stages C and D) as represented in the block diagram of FIG. 1 are shown. Stage E of FIG. 3 represents the ISA webserver storage unit where most of the obscuring and encryption processes of the present invention take place. Stage Ea represents the process where a new encryption key is generated; Eb represents the stage where the file is encrypted with the key, and stage Ec represents the process of obscuring the directory in a serial manner through sub-stages Eci.-iv, which include Eci—obscuring an affiliate folder name (128 bit); Ecii—obscuring the user folder name (128 bit); Eciii—obscuring the stage folder name (128 bit); and Eciv—obscuring the file name (128 bit). Stage F of FIG. 3 represents the process of moving the key and metadata of the encrypted file to a database server and storage unit outside of the webserver of Stage E. The webserver hosting may take place on a local or shared network, and storage units represented may be through a local database, database on a shared server, or on the cloud, or any combination of private and shared services and medium.

FIG. 4 represents the system and processes of a User of the ISA using the ISA through a computer interface to the ISA (stages A-C) in order to download files within the webserver storage unit hosting the ISA (stages C-D) as represented in the block diagram of FIG. 2. The User issues a request to download a document, via a DocRequest ID. Stage D of FIG. 4 represents the ISA webserver where most of the decryption processes of the present invention take place. Stage Da is the handler program script that receives the request from the ISA User. The stage Da script sends for the key stored in Stage F of FIG. 3, also labeled Stage F of FIG. 4. The key(s) and metadata is retrieved from its separate storage unit or units, if stored separate from each other as in some embodiments of the present invention, for every requested file. The stages represented in FIG. 4, stages Dbi-iv perform the steps necessary for the requested data retrieval, including Dbi—obscuring the associated files for the encrypted information that is to be further secured, an affiliate folder name (128 bit); Dbii—obscuring the user folder name (128 bit); Dbiii—obscuring the stage folder name (128 bit); and Dbiv—obscuring the file name (128 bit). Stage Dc represents the decryption processes of the retrieved files, and Dd represents the output of the readable decrypted reconstituted files.

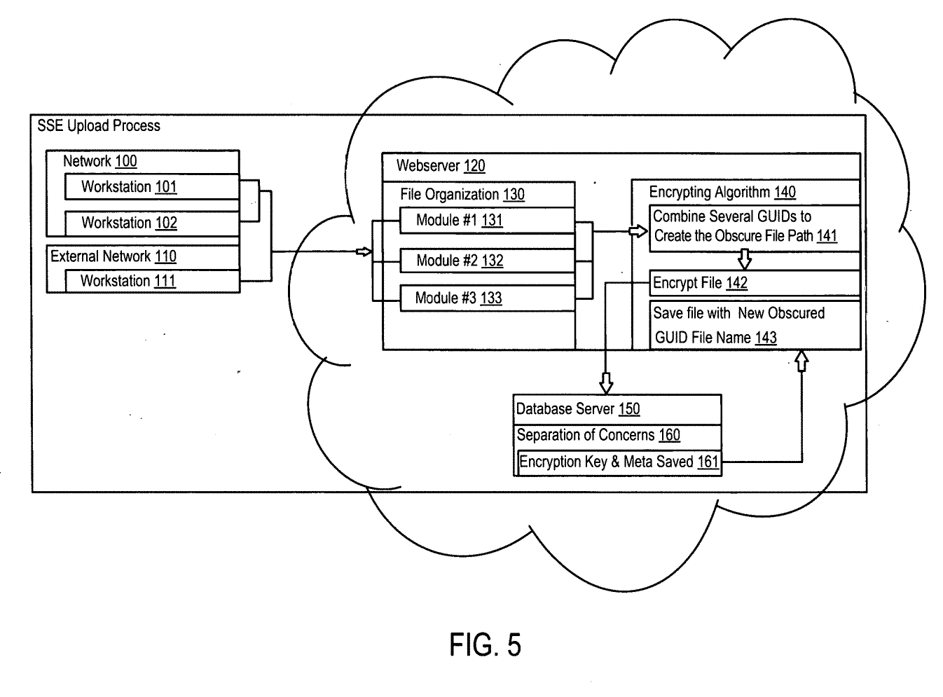

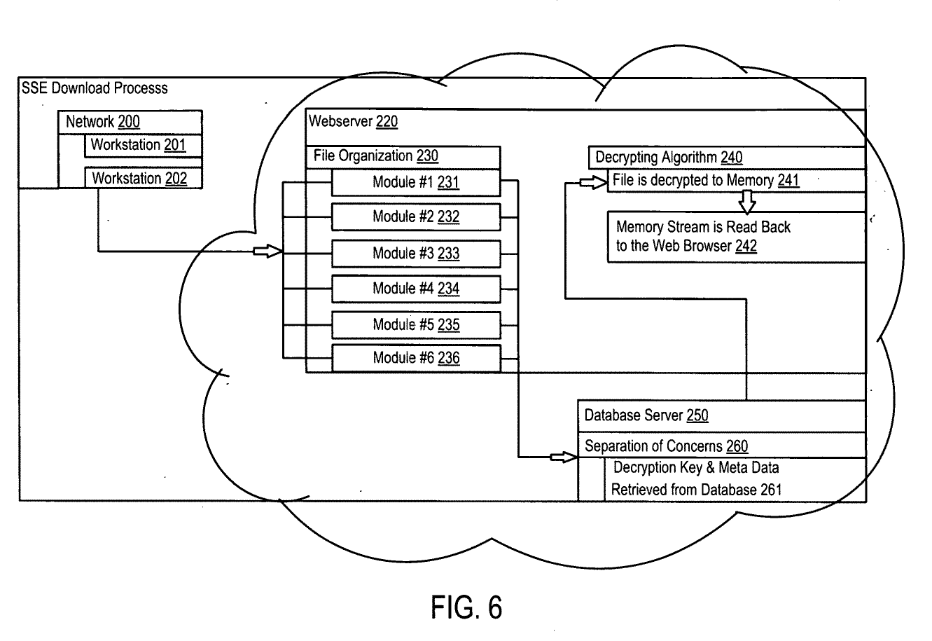

FIGS. 5 and 6 represent an alternative set of processes for uploading and downloading data to the ISA using the system of ESSSE of the present invention. Specific steps and tasks required of an exemplary ISA for a bank lender and the corresponding secured storage and retrieval of loan documents for a User or set of Users are represented. Within the ISA webserver, upload of files by one or more Users are conducted, and modules represent file organization steps 130 and 230 of, for example, 131-133 and 231-236 are various staging folders and corresponding possible upload and download functions of transferring files to the ISA and then opening them and closing them within the ISA, assigning the uploaded files to a loan package, to a submittals folder, altering the documents through a document management function, e.g. to match the format of the loan package folder, and then transferring certain of the files to a recycle bin for waste. The organized and secure loan package for a particular User of the ISA can then be transmitted upon request of the ISA administrator or authorized User to whom the secure information is assigned, subsequent to the steps performed for enhanced security of the information by the computing platform of the present invention.

Additional detail of the algorithms used in an embodiment of the ESSSE implementation computing platform of the present invention is set forth in the phases described below. The code represented, when embodied in tangible media and loaded into and executed by a computing medium, becomes a computing platform for practicing the methods and processes described herein.

Phase: Directory Obscuration. On creation of new affiliate, a 128 bit affiliateUUID is used as the root folder rather than the affiliate name. By using the affiliateUUID rather than their clear text file name it is not possible to detect the owner of the files on the filesystem without interacting with the database to decode the filesystem structure.
F:/MyAffiliateName/>>F:/AffiliateUUID

Phase: Obscure Subsequent Directories. Uploading a new file into the directory triggers the creation of an obscured directory path using additional 128 bit GUIDS that represent logical collections of data in order to conceal the intent or purpose of the file being uploaded.
1. Generation of new UUIDs
2. Create the following directories
F:/MyAffiliateName/LoanName>>F:/AffiliateUUID/LoanUUID
F:/MyAffiliateName/LoanName/ThirdParty>>
F:AffiliateUUID/LoanUUID/ThirdPartyUUID
F:/MyAffiliateName/LoanName/Attachments>>
F:/AffiliateUUID/LoanUUID/AttachmentsUUID
F:/MyAffiliateName/LoanName/OverWritten>>
F:/AffiliateUUID/LoanUUID/OverWrittenUUID

Phase: Filename Obscuration. Files saved using docUUID value as filename (sans extension: myfile.pdf>>docUUID) obscure the meaning of a file. Saving the file in a manner that does not exhibit extension or metadata further reduces the potential risk of an intruder easily understanding the purpose of a file.
F:/MyAffiliateName/LoanName/Filename.xxx>>
F:/AffiliateUUID/LoanUUID/docUUID
F:/MyAffiliateName/LoanName/ThirdParty/Filename.xxx>>
F:/AffiliateUUID/LoanUUID/ThirdPartyUUID/docUUID
F:/MyAffiliateName/LoanName/Attachments/Filename.xxx>>
F:/AffiliateUUID/LoanUUID/AttachmentsUUID/docuUID
F:/MyAffiliateName/LoanName/OverWritten/Filename.xxx>>
F:/AffiliateUUID/LoanUUID/OverWrittenUUID/docUUID

Phase: File Encryption. The files having an obscured file name are encrypted utilizing the Rijndael encryption algorithm.

Phase: Encrypt uploaded files. On file upload a new key for document and encrypt file is generated. The encryption key and file metadata is saved to a database on a separate server, whereas the encrypted file is saved to a logical location in the obscured conical path.

Phase: Decrypt prior to PDF manipulations. Prior to performing any of the PDF actions the files are decrypted into volatile memory. Upon a PDF Management manipulation request, the file is decrypted to its original form prior to performing the manipulative operation (Rotate, Extract, Compres etc). The files are then re-encrypted after any PDF manipulation has been completed using the process described in Phase 3B. The purpose of encrypting the files while the files are at rest ensures that they are unable to be opened from filesystem even with a valid windows user account. All uploaded encrypted files must be opened by a legitimate user authorized by, and within the ISA to which the information is submitted for processing and enhanced security of the present invention computing platform.

Phase: Decrypt prior to download. Upon request to download a file the ISA obtains the decryption key and meta data from the external database server. They key and metadata is then used to locate and decrypt the files to volatile memory after which the data is then sent through the internet to the requesting user.

The separation of concerns is integral to the utility of the present invention, and is implemented by storing the key in a separate database server from the files containing Proprietary Data that are stored on the web server.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should also be noted that in some alternative implementations, the functions/acts noted may occur out of the order noted in the figures. For example, two steps shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations including a processor that executes instructions stored in memory.

The embodiments can also be embodied as a non transitory computer readable code on a computer readable medium. The computer readable medium is any data storage device that can store data, which can be thereafter read by a computer system. Examples of the computer readable medium include hard drives, flash drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, cellular phones, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical . applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A computing system for enhanced security of information, comprising:
a first storage unit adapted to store the information, the first storage device including:
a key generated to encrypt the information, and
a file server to host the encrypted information, wherein the file server path name associated with the information is obscured, and
a second storage unit adapted to store the key used to encrypt the information.

2. A computing system of claim 1, wherein the second storage device also stores metadata stripped from the information.

3. A computing system of claim 1, wherein metadata stripped from the information is stored in a third storage unit.

4. A computing system of claim 1, wherein the information is transmitted from an internet service application.

5. A computing system of claim 1, wherein the first storage unit is adapted to retrieve the key stored on the second storage unit so that the encrypted information is decrypted.

6. A computing system of claim 1, wherein the first storage unit is adapted to retrieve the metadata stripped from the information, so that the encrypted information is decrypted.

7. A computing system of claim 1, wherein the key is randomly generated.

8. A method for enhanced security of information, comprising the steps of:
Generating a key;
Using the key to encrypt the information;
Stripping metadata from the information;
Storing the key and the metadata in a storage location separate from the encrypted information;
Obscuring a file path name of a file designated to store the encrypted information; and
Storing the encrypted information in the file with obscured file path name.

9. A method for enhanced security of information of claim 8, wherein the key and the metadata are stored in two separate storage locations from the encrypted information.

10. A method for enhanced security of information further comprising the step of:
Retrieving the key from its storage location to decrypt the information stored in the obscured file.

11. A method for enhanced security of information further comprising the step of:
Retrieving the metadata from its storage location to decrypt the information stored in the obscured file.

12. A method for enhanced security of information, wherein the key is randomly generated.

13. A method for enhanced security of information, wherein the obscuring step uses GUIDs to build a conical directory structure for the file path name.
